(19) United States
(12) Patent Application Publication
(10) Pub. No.: US 2025/0142619 A1
(43) Pub. Date: May 1, 2025

(54) CONFLICT RESOLUTION BETWEEN BEACON TRANSMISSION AND R-TWT SP

(71) Applicants: SONY GROUP CORPORATION, Tokyo (JP); SONY CORPORATION OF AMERICA, New York, NY (US)

(72) Inventors: Qing Xia, San Jose, CA (US); Salvatore Talarico, Los Gatos, CA (US)

(73) Assignees: SONY GROUP CORPORATION, Tokyo (JP); SONY CORPORATION OF AMERICA, New York, NY (US)

(21) Appl. No.: 18/816,241

(22) Filed: Aug. 27, 2024

Related U.S. Application Data
(60) Provisional application No. 63/564,630, filed on Mar. 13, 2024.
(60) Provisional application No. 63/594,990, filed on Nov. 1, 2023.

(51) Int. Cl. H04W 74/0816; H04W 74/08; H04W 84/12

(52) U.S. Cl. CPC H04W 74/0816; H04W 74/0875; H04W 84/12

(57) ABSTRACT

Providing conflict resolution between beacon transmission and Restricted-Target Wake Time (R-TWT) Service Periods (SPs) to enhance IEEE 802.11 protocols, especially for Extra High Throughput (EHT) Access Points (APs). After determining if a beacon will overlap the start of a TXOP and whether the beacon or R-TWT SP transmission has higher priority; the AP resolves the conflict such as to start or continue the R-TWT TID and embed the beacon frame within the transmitted frame, or to limit the TXOP to provide for transmitting the beacon frame at the proper timing.

### CROSS-REFERENCE TO RELATED APPLICATIONS

This application claims priority to, and the benefit of, U.S. provisional patent application Ser. No. 63/594,990 filed on Nov. 1, 2023, incorporated herein by reference in its entirety. This application claims priority to, and the benefit of, U.S. provisional patent application Ser. No. 63/564,630 filed on Mar. 13, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to wireless communications using restricted target wake time (R-TWT), and more particularly to wireless communications under IEEE 802.11be which addresses priority issues between beacon frames and R-TWT service periods (SPs), and UL/DL R-TWT TID traffic transmission sequences.

### 2. Background Discussion

Restricted Target Wake Time (R-TWT) is an important feature of IEEE 802.11be, also referred to as Wi-Fi7, to prioritize low latency traffic within a protected Service Period (SP) for R-TWT member STAs. In addition, IEEE 802.11be provides for the use of multi-link operations (MLOs). Channel access rules have been specified in IEEE 802.11be Draft P802.11be_D4.0 for R-TWT SPs and for applying both trigger-enabled and non-trigger-enabled SPs. However, issues arise in the existing IEEE 802.11be protocol regarding beacon frame versus R-TWT SP priority which limit operational efficiency.

Accordingly, a need exists for an enhanced IEEE 802.11be protocol for addressing beacon and R-TWT SP priorities. The present disclosure fulfills that need and provides additional benefits over existing systems.

### BRIEF SUMMARY

Enhancement of the existing IEEE 802.11be wireless protocol (WiFi7) to provide conflict resolution between beacon transmission and Restricted-Target Wake Time (R-TWT) channel access rules. In particular, an Extra High Throughput (EHT) Access Point (AP), as Transmit Opportunity (TXOP) holder, provides conflict resolution after determining that its transmitted beacon will overlap the starting point of an R-TWT SP, then the EHT AP decides whether the beacon transmission or R-TWT SP has a higher priority, and uses rules to address these priorities. In addition, the EHT AP, as Transmit Opportunity (TXOP) holder, after determining that its transmitted beacon will overlap a Downlink (DL) or Uplink (UL) transmission at the starting point of the R-TWT SP decides whether to start or continue the transmission satisfying the R-TWT TID and embed the beacon frame within the transmitted frame, or to limit the TXOP to provide for transmitting the beacon frame at the proper timing.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a block diagram of Multi-Link Device (MLD) hardware according to at least one embodiment of the present disclosure.

FIG. 3 is a topology diagram exemplifying an EHT AP interacting with a non-AP STA within a BSS toward aiding the discussion according to at least one embodiment of the present disclosure.

FIG. 4 is a data field diagram of a Traffic Information Control field, according to at least one embodiment of the present disclosure.

FIG. 5 is data table showing mapping of DL TID subfield indications, according to at least one embodiment of the present disclosure.

FIG. 6A and FIG. 6B is a flow diagram of EHT AP operations for overcoming priority issues between timely Beacons frame transmissions and transmissions within R-TWTs, according to at least one embodiment of the present disclosure.

FIG. 7 is a communications diagram of Example 10.1 in which beacon transmission priority is higher than the R-TWT scheduling priority at the commencement of a R-TWT SP, according to at least one embodiment of the present disclosure.

FIG. 8 is a communications diagram of Example 10.2 in which beacon transmission priority is lower than R-TWT scheduling priority at the start of a R-TWT SP, according to at least one embodiment of the present disclosure.

FIG. 9 is a communications diagram of Example 10.3 in which the beacon is embedded with DL R-TWT TID traffic in an FDD manner, according to at least one embodiment of the present disclosure.

FIG. 10 is a communications diagram of Example 10.4 in which the beacon is embedded within the DL R-TWT TID traffic in a Time Division Duplex (TDD) manner, according to at least one embodiment of the present disclosure.

FIG. 11 is a communications diagram of Example 10.5 in which the AP TXOP shrinkage is performed prior to beacon transmission, according to at least one embodiment of the present disclosure.

### DETAILED DESCRIPTION

### 1. Introduction

R-TWT is one of the key features designed in Wi-Fi7 (IEEE 802.11be) to prioritize low latency traffic within a protected service period (SP) for R-TWT member STAs. In 802.11be, the EHT AP and its associated non-AP EHT STAs can negotiate a R-TWT SP for transmitting latency sensitive UL/DL traffic with specific TIDs. A quiet interval starts at the starting point of the R-TWT SP and prevents legacy non-AP STAs from accessing the medium during this protected interval. The non-AP EHT STAs, which have been granted membership in the R-TWT SP and the R-TWT scheduling AP, can contend for channel access and transmit UL/DL PPDUs or trigger UL trigger-based (TB) PPDUs during this quiet interval. The non-AP EHT STAs, which haven't been granted membership in the R-TWT SP, may follow the quiet rule and thus will not access the medium during this quiet interval. In this case, the R-TWT SP prioritizes the R-TWT member STAs by reducing the contention from the non-AP EHT STAs that are following the quiet rules at the start of the partial R-TWT SP, so that the R-TWT SP prioritized R-TWT member STAs can easily transmit latency sensitive traffic. Since non-AP EHT STAs may ignore any overlapping quiet interval at the starting point of the R-TWT SP, R-TWT scheduling has an additional rule which is to terminate the TXOP of the TXOP holder at the starting point of the R-TWT SP to further prioritize channel access of the R-TWT AP and the R-TWT member STAs.

Another key feature introduced in IEEE 802.11 be is multi-link operation (MLO). A device that supports MLO is called a Multi-Link Device (MLD), which has multiple affiliated STAs and each of the affiliated STAs operates over one of the multiple-links. The R-TWT could apply to non-AP EHT MLD STAs, which may support Simultaneous Transmit and Receive (STR) mode or non-STR (NSTR) modes. The STR mode allows the MLD to be transmitting over one link of the STR link pair, while simultaneously receiving over another link of the STR link pair. Comparatively, the NSTR mode does not support the MLD transmitting over one link of the NSTR link pair while simultaneously receiving over another link of the NSTR link pair.

### 2. Channel Access

Channel access rules have been specified in IEEE 802.11be Draft P802.11be_D4.0 for R-TWT SPs, and apply to both trigger-enabled and non-trigger-enabled SPs. The R-TWT supporting STA as a TXOP holder shall ensure that the TXOP ends before the start time of any active R-TWT SPs that are advertised by its associated AP. The R-TWT scheduling AP, as a TXOP holder, shall ensure that the TXOP ends before the starting time of any active R-TWT SPs advertised by itself, unless the remaining portion of the TXOP has fallen within the R-TWT SP utilized for delivery of DownLink (DL) frames of R-TWT DL TID(s), or to solicit UpLink (UL) frames of R-TWT UL TID(s).

The R-TWT supporting STA checks if there is sufficient time for the frame exchange to be completed prior to the start of the R-TWT SP, and if there is insufficient time, then the STA defers transmission by selecting a random backoff counter using the present value of the Contention Window (CW); without advancing to the next value in the sequence. It should be noticed, for the above, that the QoS Short Retry Counter (QSRC)[AC] for the MAC Service Data Unit (MSDU) or Aggregated-MSDU (A-MSDU) is not affected. When an R-TWT SP commences, a R-TWT scheduled STA may suspend decrementing the backoff counter of any Access Class (AC) that does not have any R-TWT TID(s) mapped to it, until it has delivered all its frames from R-TWT TID(s), and resumes decrementing afterwards or when the SP is ended. To schedule a trigger-enabled R-TWT SP, the trigger enabled parameter in the configurable R-TWT schedule parameter should be set to a value of 1.

In addition to these channel access rules, the following rules should also be applied. When scheduling the transmission of Trigger frames, the R-TWT scheduling AP shall first trigger R-TWT scheduled STAs to deliver Quality of Service (QOS) Data frames of R-TWT UL TID(s), if any. The triggered R-TWT scheduled STA shall first include QoS Data frames (if any) of TID(s) in the R-TWT UL TID(s) in the aggregated MAC Protocol Data Unit (MPDU). The triggered R-TWT scheduled STA can aggregate the multi-TID MPDU. The R-TWT scheduling AP should schedule trigger frames at the start of the R-TWT SPs.

Beacon transmission rules for non-Directional Multi-Gigabit (non-DMG) infrastructure networks have been specified in IEEE 802.11be Draft P802.11REVme_D4.0, which have not been updated or modified in IEEE 802.11be Draft P802.11be_D4.0, which implies that these rules also apply for IEEE 802.11be. In particular, beacon transmission is performed according to a series of Target beacon Transmission Times (TBTTs), which describe the timing defined by the AP for the entire Basic Service Set (BSS) by transmitting beacon frames every ‘dot11BeaconPeriod’ Time Units (TUs) apart. Time 0 is defined to be the reference starting time for TBTT when the first beacon frame is expected to be sent. At each TBTT, the AP shall schedule a beacon frame as the next frame to access the medium for transmission. However, the transmission of a beacon frame might be delayed because of Carrier Sense Multiple Access (CSMA) deferrals, and subsequent beacon frames are scheduled at the nominal beacon interval.

### 3. Problem Statement

Issues can arise in IEEE 802.11be with conflicts between periodic beacon transmissions and data transmissions.

(1) A conflict exists between the beacon frame transmission rule as defined in IEEE 802.11be Draft P802.11REVme_D4.0 subclause “11.1.3.2 beacon generation in non-DMG infrastructure networks” and the channel access rule for R-TWT SP as defined in IEEE 802.11be Draft P802.11be_D4.0 subclause “35.8.4.1 TXOP and backoff procedures rules for R-TWT SPs”.

Within subclause 11.1.3.2 beacon generation in non-DMG infrastructure networks, the baseline specifies that “the AP suspends any pending transmissions until the beacon has been transmitted”, which grants the beacon frame the highest priority.

However, in subclause 35.8.4.1 describing the TXOP and backoff procedure rules for R-TWT SPs, the specification indicates rules as outlined below, which instead grants the R-TWT schedule the highest priority: (a) For single link and STR Multi-Link (ML) operations: it states that “An EHT AP with ‘dot11RestrictedTWTOptionImplemented’ is set to true as a TXOP holder shall ensure the TXOP ends before the start time of any active R-TWT SP advertised by itself as specified in 35.8.3 (R-TWT announcement) unless the remaining portion of TXOP falling within the R-TWT SP is used for the delivery of DL frames of R-TWT DL TID(s) or to solicit the UL frames of R-TWT UL TID(s).” (b) For NSTR ML operation, the specification states that “When a non-AP STA that is affiliated with a non-AP MLD and operates on one link of an NSTR link pair, or one of the EMLSR or EMLMR links is a member of a R-TWT SP on the first link; if the second non-AP STA affiliated with the same MLD is not a member of any other R-TWT SPs on the second link that overlap with the first SP, then the second non-AP STA and its associated AP (referred as the second AP), if their respective ‘dot11 RestrictedTWTOptionImplemented’ equal to true, should follow the rules below.

(a) The second AP as a TXOP holder on the second link should ensure its frame exchanges end no later than ‘T’ amount of time before the start time of the R-TWT SP on the first link, if the second non-AP STA is the corresponding TXOP responder or one of the responders.

(b) The second non-AP STA as a TXOP holder on the second link should ensure its TXOP ends no later than ‘T’ amount of time before the start time of the R-TWT SP on the first link.

(2) Interruptions exist between beacon frame transmission and the UL/DL (with R-TWT UL/DL TID) traffic transmission and the corresponding frame exchange sequences during R-TWT SPs. Following the baseline rule in Draft P802.11REVme_D4.0 to allow the AP to suspend any pending transmissions until the beacon has been transmitted, can lead to deferred DL transmissions from the AP. The deferred DL Data transmission could either cause inefficient channel utilization during the R-TWT SP and/or a loss of priority during the overlapping quiet interval, or cause non-AP STAs to obtain the channel access and to further block beacon frame transmission. The deferred DL control frame sent in response to the received UL PPDU could cause the UL PPDU source non-AP STA to retransmit the UL PPDU after the response frame times out.

Other management frames may also experience the same conflict issue as the beacon frame transmission with the starting point of an R-TWT SP. The conflict of other management frames with the starting point of an R-TWT SP should also be resolved.

### 4. Contribution of the Present Disclosure

This disclosure provides several solutions on how to resolve the conflict between the baseline rule in IEEE 802.11be Draft P802.11REVme_D4.0 that prioritizes the beacon transmission over R-TWT and the 11be specification rule in IEEE 802.11be Draft P802.11be_D4.0 that prioritizes the R-TWT schedule at the starting point of R-TWT SPs.

This disclosure further resolves beacon frame interruption to Trigger Based (TB) UL/DL transmissions with prioritized R-TWT UL/DL TID traffic and the corresponding frame exchange sequences during R-TWT SP, which is an area that has not been considered in the current IEEE 802.11be draft specification. Accordingly, this disclosure further resolves the issue in regard to management frames in general, and not only beacon frames which are one form of management frame, causing interruptions at the starting point of the R-TWT SP.

### 5. Hardware Embodiments

### 5.1. Communication Station (STA and MLD) Hardware

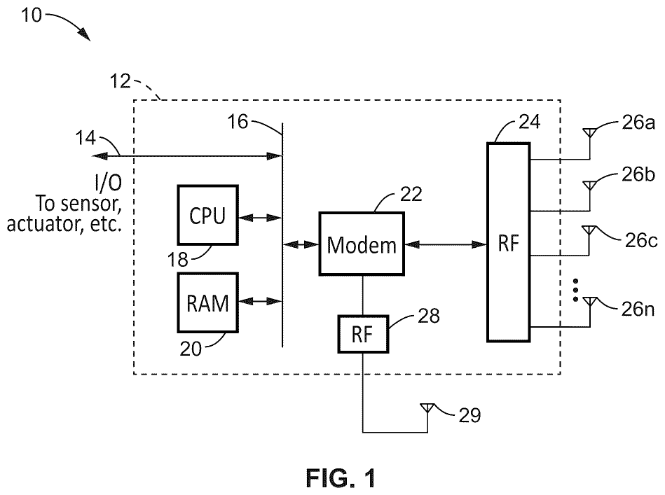

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows for performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an access point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

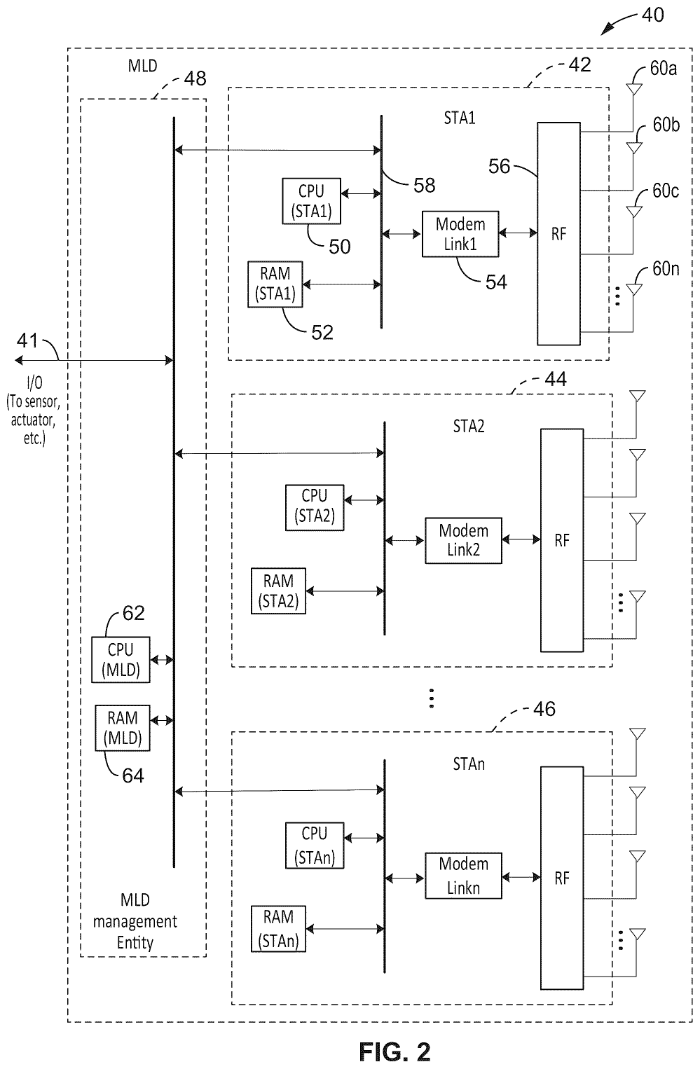

FIG. 2 illustrates an example embodiment 40 of a Multi-Link Device (MLD) hardware configuration. It should be noted that a “Soft AP MLD” is a MLD that consists of one or more affiliated STAs, which are operated as APs. A soft AP MLD should support multiple radio operations, for example on 2.4 GHz, 5 GHz and 6 GHz. Among multiple radios, basic link sets are the link pairs that satisfy simultaneous transmission and reception (STR) mode, e.g., basic link set (2.4 GHz and 5 GHZ), basic link set (2.4 GHz and 6 GHZ).

The conditional link is a link that forms a non-simultaneous transmission and reception (NSTR) link pair with some basic link(s). For example, these link pairs may comprise a 6 GHz link as the conditional link corresponding to 5 GHz link when 5 GHz is a basic link; 5 GHz link is the conditional link corresponding to 6 GHz link when 6 GHz is a basic link. The soft AP is used in different scenarios including Wi-Fi hotspots and tethering.

Multiple STAs are affiliated with an MLD, with each STA operating on a link of a different frequency. The MLD has external I/O access to applications, this access connects to a MLD management entity 48 having a CPU 62 and memory (e.g., RAM) 64 to allow executing a program(s) that implements communication protocols at the MLD level. The MLD can distribute tasks to, and collect information from, each affiliated station to which it is connected, exemplified here as STA 1 42, STA 2 44 through to STA N 46 and the sharing of information between affiliated STAs.

In at least one embodiment, each STA of the MLD has its own CPU 50 and memory (RAM) 52, which are coupled through a bus 58 to at least one modem 54 which is connected to at least one RF circuit 56 which has one or more antennas. In the present example the RF circuit has multiple antennas 60a, 60b, 60c through 60n, such as in an antenna array. The modem in combination with the RF circuit and associated antenna(s) transmits/receives data frames with neighboring STAs. In at least one implementation the RF module includes frequency converter, array antenna controller, and other circuits for interfacing with its antennas.

It should be appreciated that each STA of the MLD does not necessarily require its own processor and memory, as the STAs may share resources with one another and/or with the MLD management entity, depending on the specific MLD implementation. It should be appreciated that the above MLD diagram is given by way of example and not limitation, whereas the present disclosure can operate with a wide range of MLD implementations.

### 6. Topology

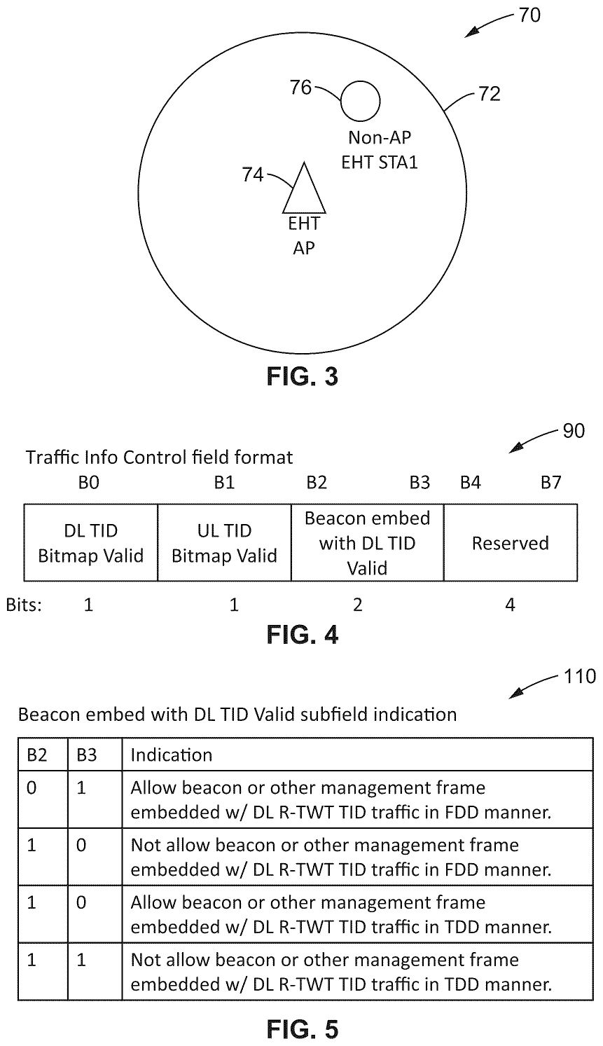

FIG. 3 illustrates an example topology 70 depicting two EHT devices in BSS1 72, including an EHT AP 74 and a non-AP EHT STA1 76. Both EHT AP and non-AP EHT STA1 can be either a single link device or a MLD depending on the specific description of each example. In the case of the EHT AP being a MLD, then it has AP1 and AP2 affiliated with it; with AP1 operated on link1 and AP2 operating on link2. In the case of the non-AP EHT STA being an MLD, it has STA1 and STA2 affiliated with it, and STA1 operating on link1 and STA2 operating on link2. Link1 and link2 may belong to the same STR link pair, or NSTR link pair, depending on the specific description of each example. In the NSTR case, link1 is the primary link and link2 is the non-primary link.

The protocol of the present disclosure is designed toward resolving issues that may arise in different stages of the R-TWT SP. The disclosed protocol presents this design as follows.

### 7. Protocol Description

In Section 7.1. is described conflict resolution when beacon or other management frames, such as Association Response frame, Reassociation Response frame, Probe Response frame and Authentication frame, TXOP overlaps the starting point of a R-TWT SP. This section describes resolving the issue including the following cases. In Section 7.1.1. is seen the case in which the transmission priority of a beacon, or other management frames such as Association Response frame, Reassociation Response frame, Probe Response frame and Authentication frame, is higher than the priority of the scheduled R-TWT. In Section 7.1.2. it is seen the case in which the transmission priority of the beacon, or other management frames such as Association Response frame, Reassociation Response frame, Probe Response frame and Authentication frame, is lower than R-TWT schedule priority. In Section 7.2. is described conflict resolution in the case in which a beacon, or another management frame such as Association Response frame, Reassociation Response frame, Probe Response frame and Authentication frame, interrupts the UL/DL traffic transmission during the R-TWT SP. In this section the issue is seen being resolved for both trigger-based UL transmission and DL transmission.

### 7.1. Conflict Resolution when Beacon or Other Management Frame TXOP Overlaps the Starting Point of the R-TWT SP

### 7.1.1. Beacon Transmission and Other Management Frames in which Priority is Higher than R-TWT Scheduled Priority

In this case, the present disclosure modifies the operations described in Draft P802.11be_D4.0 to allow the EHT AP as the TXOP holder to continue transmitting its beacon frame at the starting point of the R-TWT SP, which is either on the operating link of the AP, or on another link of the NSTR link pair of a non-AP MLD that is associated with the AP MLD to which the AP is affiliated.

As an example, for single link and STR ML operations, the specification rule for the AP in Draft P802.11be_D4.0 can be updated as described below.

(a) The sections describing “an EHT AP with dot11 RestrictedTWTOptionImplemented′ set to true as a TXOP holder shall ensure the TXOP ends before the start time of any active R-TWT SP advertised by itself as specified in 35.8.3 (R-TWT announcement) unless the TXOP is for transmitting a beacon frame or the remaining portion of TXOP falling within the R-TWT SP is used for the delivery of DL frames of R-TWT DL TID(s) or to solicit the UL frames of R-TWT UL TID(s)”; is changed. Specifically, the restriction of the “TXOP is for transmitting a beacon frame” is removed, and the present disclosure operates in that manner for both the beacon frame, or other management frame.

(b) In addition, the section describing “A non-AP EHT STA with dot11 RestrictedTWTOptionImplemented set to true as a TXOP holder shall ensure the TXOP ends before the start time of any active R-TWT SPs that are advertised by its associated AP that does not correspond to a non-transmitted BSSID”; is modified in the present disclosure to recite that this occurs “unless the non-AP EHT STA is transmitting a Management frame.”

For NSTR ML operation, the specification rules as in Draft P802.11be_D4.0 can be updated as described in the following:

(a) “When a non-AP STA that is affiliated with a non-AP MLD and operates on one link of an NSTR link pair, or one of the EMLSR or EMLMR links is a member of a R-TWT SP on the first link; if the second non-AP STA affiliated with the same MLD is not a member of any other R-TWT SPs on the second link that overlap with the first SP, then the second non-AP STA and its associated AP (referred as the second AP), if their respective dot11 RestrictedTWTOptionImplemented equal to true, should follow the rules below:

(i) The second AP as a TXOP holder on the second link should ensure its frame exchanges end no later than T amount of time before the start time of the R-TWT SP on the first link if the second non-AP STA is the corresponding TXOP responder or one of the responders, unless the second AP is transmitting a beacon frame or other Management frames, selected from the group of other management frames consisting of Association Response frame, Reassociation Response frame, Probe Response frame and Authentication frame;

(ii) The second non-AP STA as a TXOP holder on the second link should ensure its TXOP ends no later than T amount of time before the start time of the R-TWT SP on the first link, unless the second non-AP STA is transmitting a Management frame, selected from the group of other management frames consisting of Beacon frame, Association Request frame, Reassociation Request frame, Probe Request frame and Authentication frame.”

In the above specification recitations, to which the hierarchy lettering (a), (i) and (ii) has been added herein, the following changes are supported by the present disclosure. In element (a)(i) above, the stipulation would be added at the end that “unless the second AP is transmitting a beacon frame or other management frame selected from the group of other Management frames consisting of Beacon frame, Association Response frame, Reassociation Response frame, Probe Response frame and Authentication frame”. In element (a)(ii) the stipulation in the present disclosure would be added at the end that “unless the second non-AP STA is transmitting a Management frame, such as Beacon frame, Association Request frame, Reassociation Request frame, Probe Request frame and Authentication frame.”

### 7.1.2. Beacon or Other Management Frame Transmission Priority is Lower than R-TWT Scheduled Priority

In this case, in one option the current channel access rules for R-TWT SP as defined in Draft P802.11be_D4.0 could be followed. Over this baseline of rules, some additional rules need to be defined for beacon frame or other Management frame transmission/termination around the starting point of R-TWT SPs, which are listed as follows:

The EHT AP as the TXOP holder should not transmit a beacon frame or other Management frame, such as Association Response frame, Reassociation Response frame, Probe Response frame and Authentication frame, if the beacon frame or other Management frame will overlap the starting point of the R-TWT SP, which is either on the AP's operating link or on another link of the NSTR link pair of a non-AP MLD that is associated with the AP MLD of which the AP is affiliated with.

The EHT AP suspends any pending transmissions until the beacon has been transmitted, unless the beacon frame has been deferred due to the channel access rules for R-TWT SPs as defined in Draft P802.11be_D4.0.

After the R-TWT SP commences, the EHT AP can begin contending for channel access so that it can transmit the beacon frame or other Management frame, such as Association Response frame, Reassociation Response frame, Probe Response frame and Authentication frame, which was deferred by it supporting the TXOP termination rule at the start point of the R-TWT SP.

In another option, rather than allowing the beacon or other management frame transmission to be deferred indefinitely the EHT AP may follow or more of the following criteria: (1) attempt a limited number of times to transmit it, and in case it won't succeed, it may need to wait until the start of the next beacon frame interval or next time of sending the Management frame; and/or (2) a timer is defined which starts counting from the start of the R-TWT, and upon expiration of the timer, the EHT AP may no longer be allowed to transmit a beacon frame or other Management frame.

### 7.2. Conflict Resolution when a Beacon Frame Interrupts the UL/DL Traffic Transmission During the R-TWT SP

When an EHT AP as the TXOP holder has a beacon frame or other Management frame, such as Association Response frame, Reassociation Response frame, Probe Response frame and Authentication frame, to transmit and in parallel has DL/UL traffic with R-TWT DL/UL TID(s) to be transmitted, or to solicit inside a R-TWT SP; then instead of suspending any pending transmissions until a beacon or other management frame has been transmitted, the EHT AP can apply one or more of the following options.

(1) The EHT AP can start/continue the DL pending transmissions by embedding the beacon frame or other Management frame, such as Association Response frame, Reassociation Response frame, Probe Response frame and Authentication frame, in the same DL frame with the pending transmissions.

(a) The EHT AP can either embed the beacon frame or other Management frame, such as Association Response frame, Reassociation Response frame, Probe Response frame and Authentication frame, in a Frequency Domain Division (FDD) manner or in a time domain division (TDD) manner. It will be noted that FDD requires two separate wireless communication channels on separate frequencies, one for transmit and the other for received data.

(b) When using an FDD manner, the beacon frame or other management frame, such as Association Response frame, Reassociation Response frame, Probe Response frame and Authentication frame, shall be embedded to occupy at least the primary 20 MHz channel to assure that every non-AP STA associated with this EHT AP can hear the beacon or other management frame.

(2) The EHT AP can start a limited TXOP of the DL pending transmissions and the corresponding frame exchange sequences be given in the TXOP for transmitting a beacon frame at the TBTT.

(a) The EHT AP can continue the TXOP to transmit the beacon frame or other management frame, such as Association Response frame, Reassociation Response frame, Probe Response frame and Authentication frame, without the need to contend for the channel, if the EHT AP just finishes the DL transmission right before the beacon frame or other management frame.

(b) The EHT AP can continue the TXOP to transmit the remaining DL pending transmissions without the need to contend for the channel if the EHT AP has just completed transmitting a beacon or other management frame, such as Association Response frame, Reassociation Response frame, Probe Response frame and Authentication frame, and if it is not violating the TXOP limitation.

### 8. Frame Format

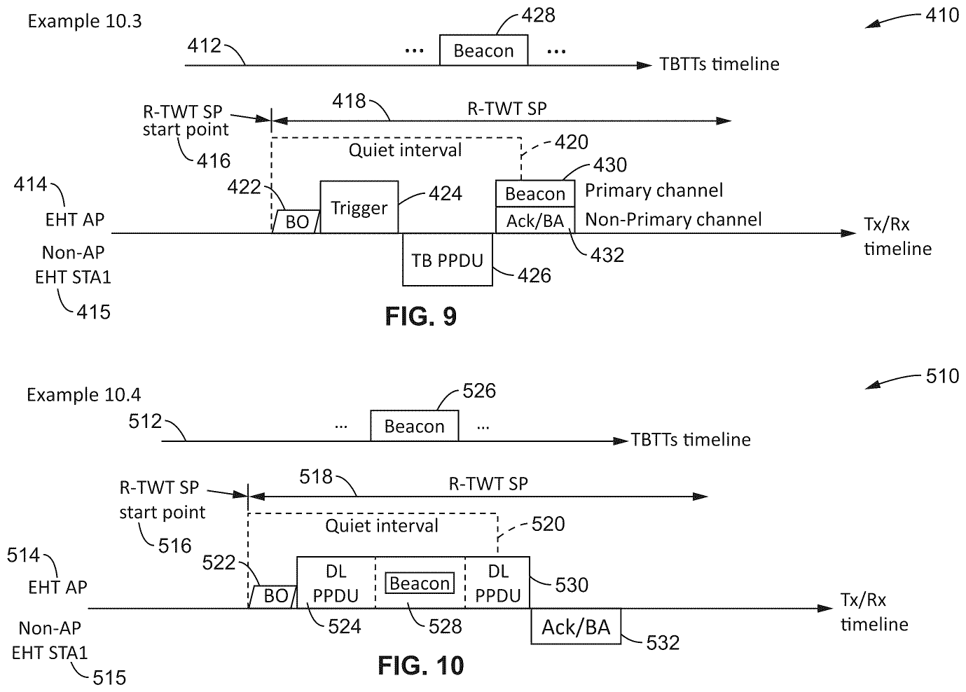

FIG. 4 illustrates an example embodiment 90 of a modified Traffic Control field format in the Restricted TWT Traffic Info field based on FIG. 9-765b in IEEE 802.11be Draft P802.11be_D4.0, which originally has B2-B7 as Reserved. The element is shown with fields DL TID Bitmap Valid, UL TID Bitmap Valid, and has been modified with the new field Management Embedded with DL TID Valid, with some remaining Reserved bits (B4-B7).

FIG. 5 illustrates an example 110 of subfield indication in which B2-B3 is utilized to indicate the manner of embedding the beacon frame or other management frame with DL TID traffic as indicated in this chart. beacon or other management frames are embedded with DL TID Valid subfield indication. The four possible states indicated by B2-B3, show a selection between allowing or disallowing either beacon or other management frames to be embedded with DL R-TWT TID traffic in either an FDD or TDD manner. It should be appreciated that the present invention is not limited to the exemplified order of the indications, the number of different indications included, and the specific encoding for denoting these indications, as these may be modified by one of ordinary skill in the art without departing from the teachings of the present disclosure.

The R-TWT scheduling AP and the R-TWT scheduled STAs negotiate to determine if they will support embedding a beacon frame or other management frame within the DL R-TWT TID traffic when setting up the R-TWT schedule.

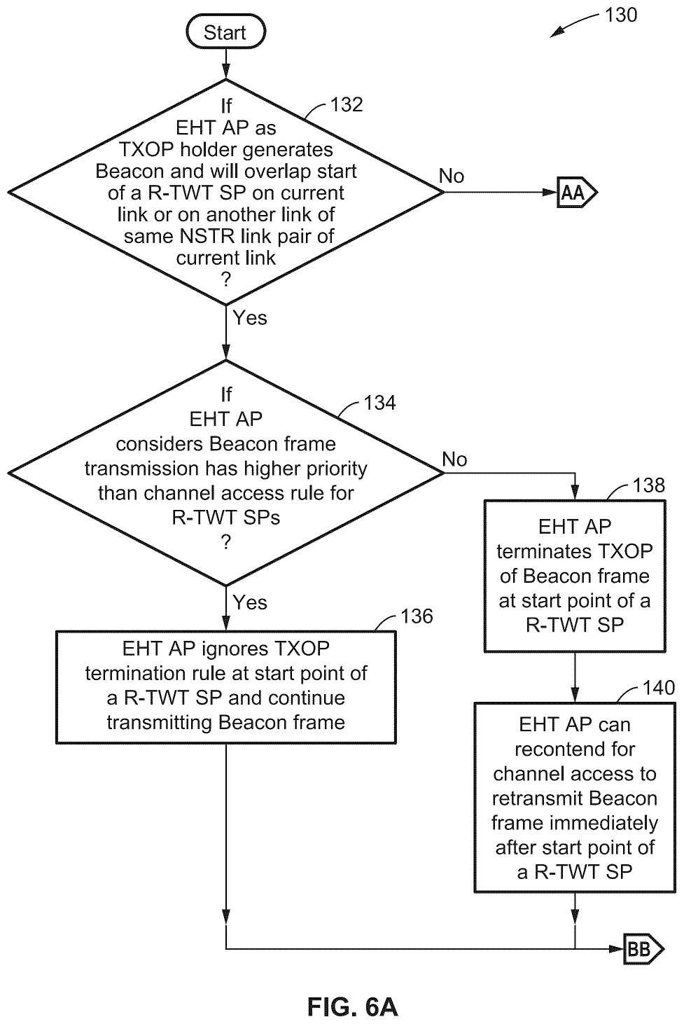

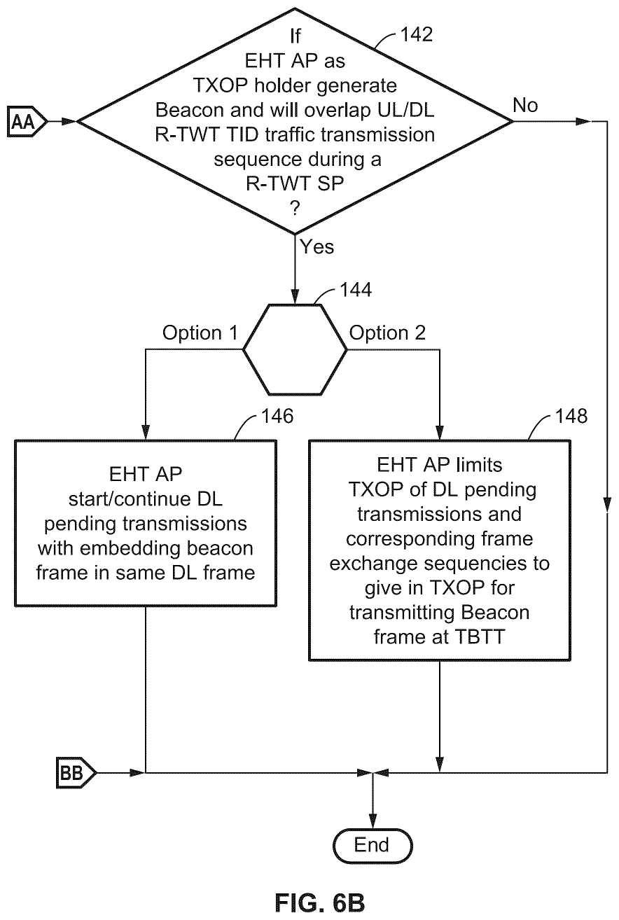

FIG. 6A and FIG. 6B illustrate an example embodiment 130 of operations of the EHT AP toward overcoming priority issues between timely beacon frame transmissions and data transmissions.

### 9. Flow Diagram

In check 132 it is determined if the EHT AP as TXOP holder has generated a beacon that will overlap the start of a R-TWT SP on the current link, or on another link of the same NSTR link pair of the current link.

If the condition is met, then check 134 determines if the EHT AP considers (has determined) that the beacon frame transmission has higher priority than the channel access rule for R-TWT SPs. If it is considered higher priority, then the EHT AP ignores the TXOP termination rule at the starting point of the R-TWT SP and continues transmitting beacon frames, and processing ends.

Otherwise, since the condition is not met, then at block 138 the EHT AP terminates the TXOP associated with the beacon frame at the starting point of a R-TWT SP. Then the EHT AP can recontend 140 for channel access to retransmit beacon frames immediately after the starting point of a R-TWT SP, and processing ends.

Returning now to consider if the condition of check 132 is not met, wherein processing moves to check 142 in FIG. 6B that determines if the EHT AP as TXOP has generated a beacon that will overlap a UL/DL R-TWT TID traffic transmission sequence during an R-TWT SP. If the condition is not met, then processing is completed.

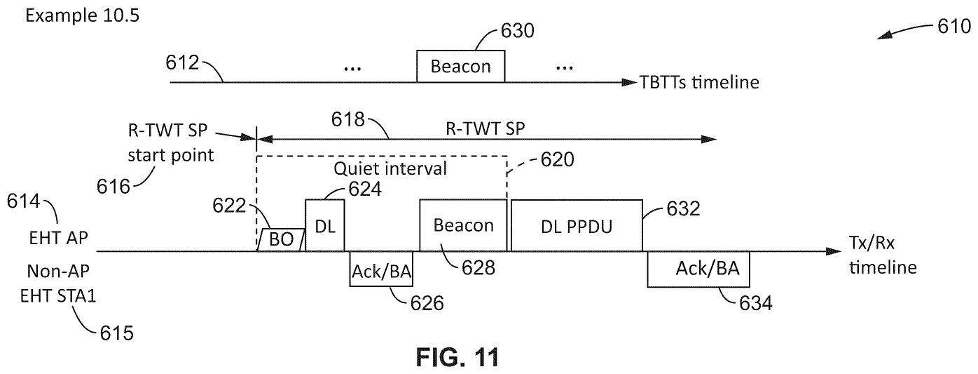

Otherwise, as the beacon will overlap, the EHT AP has to decide 144 and execute one of two options. It should be noted that option 1 and option 2 are implementation dependent. The corresponding examples are shown in FIG. 10 and FIG. 11 for option 1 and option 2, respectively. In option 1 block 146, the EHT AP starts or continues its DL pending transmissions while embedding the beacon frame in the same DL frame, after which processing is completed. In option 2 of block 148, the EHT AP limits the TXOP of the DP pending transmissions and corresponding frame exchange sequences to give in the TXOP for transmitting a beacon frame at the TBTT, with processing completed.

### 10. Example Communications

### 10.1. Beacon Transmission Priority is Higher than R-TWT Scheduling Priority at the Start Point of a R-TWT SP

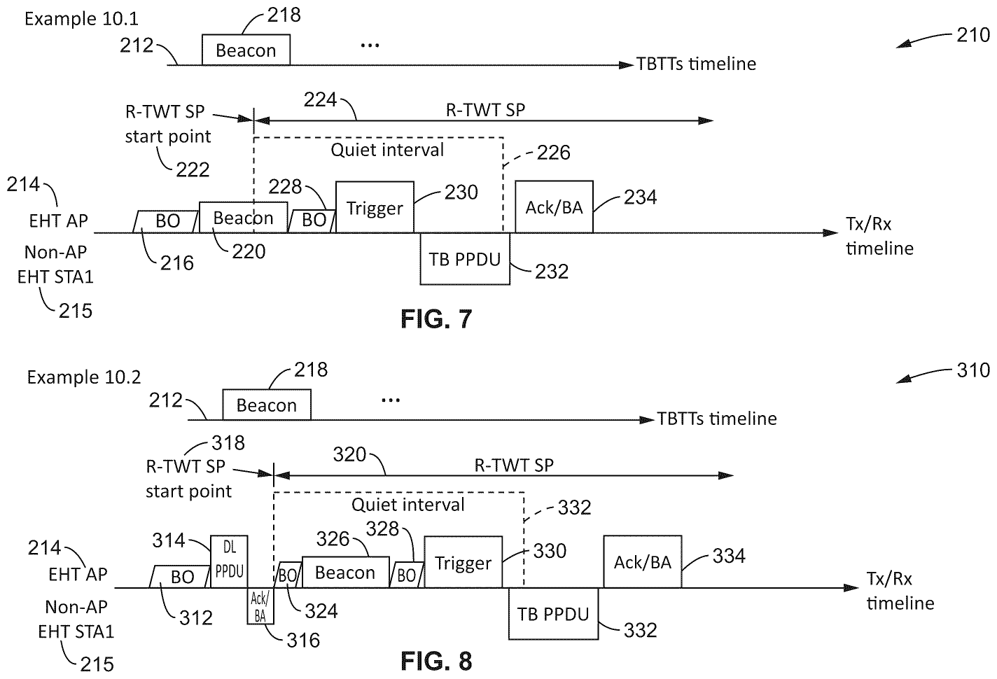

FIG. 7 illustrates Example 10.1 of a case 210 in which beacon transmission priority is higher than the R-TWT scheduling priority at the commencement of a R-TWT SP. The example depicts communications between an EHT AP 214 and a non-AP EHT STA1 215, which are single link STAs.

It should be noted that in FIG. 7 through FIG. 11 the upper line and portion of the figure shows a TBTT timeline for reference. It should be noted that this TBTT timeline does not represent a real transmission, but is the timeline of a scheduled beacon transmission; since the AP should try to broadcast beacon frames periodically at each TBTT (Target beacon Transmission Time). Whether the AP can perform this transmission, or not, depends on channel conditions at the TBTT, for example if the channel is busy and used by other STAs, the AP needs to hold the beacon frame until the current TXOP is finished and the AP can try to access the channel to broadcast the Beacon. It is the second line, in the lower portion of the figure, below the TBTT timeline which reflects the actual transmission and reception on the channel, and thus on some figures the planned beacon transmission time as seen on the first line is not the same as the actual transmission time as reflected on the second line.

In this figure the TBTT timeline 212 is shown indicating the scheduled timing for beacon 218, which in this example, corresponds to the actual time of its transmission.

The transmission sequence is as follows. EHT AP 214 performs a backoff (BO) 216 and obtains TXOP 224 and transmits a beacon frame 220, which overlaps with the starting point 222 of the R-TWT SP 224, and its quiet interval 226. The EHT AP continues transmitting the beacon frame at the starting point of the R-TWT SP until it completes beacon frame transmission 220. Then the EHT AP recontends 228 for channel access and then transmits a Trigger frame 230, which solicits UL TB PPDU 232 from the non-AP EHT STA1 215. The EHT AP then responds 234 with an Ack or BlockAck frame.

### 10.2. Beacon Transmission Priority Lower than R-TWT Scheduling Priority at the Starting Point of a R-TWT SP

FIG. 8 illustrates Example 10.2 of a case 310 in which beacon transmission priority is lower than R-TWT scheduling priority at the start of a R-TWT SP. The example depicts communications between an EHT AP 214 and a non-AP EHT STA1 215, which are single link STAs. TBTT timeline 212 is shown indicating the scheduled timing for beacon 218.

As shown in this example EHT AP 214 generates the beacon frame close to the start point of an R-TWT SP and the time left before the start time of the R-TWT SP is insufficient for the EHT AP to finish the beacon transmission. Instead of transmitting the beacon frame, the EHT AP obtains the TXOP and transmits DL PPDU 314 and then receives the Ack or BlockACK 316 in response from the non-AP EHT STA1 right before the commencement of the R-TWT SP. After the starting point of the R-TWT SP, the EHT AP recontends 324 for channel access and obtains the TXOP to transmit beacon frame 326. Then the EHT AP recontends 328 for channel access and obtains the TXOP to transmit Trigger frame 330, which solicit the UL TB PPDU 332 from the non-AP EHT STA1. The EHT AP then responds 334 with an Ack or BlockAck frame.

### 10.3. Beacon Embedded with DL R-TWT TID Traffic in FDD Manner

FIG. 9 illustrates Example 10.3 of the case 410 in which the beacon is Embedded with DL R-TWT TID traffic in an FDD manner. The example depicts communications between an EHT AP 414 and a non-AP EHT STA1 415. The TBTT timeline 412 is shown indicating the scheduled timing for beacon 428.

As shown in this example, EHT AP and non-AP EHT STA1 are single link STAs and the EHT AP performs backoff 422 to obtain the channel in R-TWT SP 418 during quiet interval 420 and transmits a Trigger frame 424 after the start of the R-TWT SP. The Trigger frame solicits UL TB PPDU 426 from the non-AP EHT STA1 415. Before the EHT AP responds with Ack or BlockACK frame 432, the EHT AP has a beacon frame 430 generated at TBTT. The EHT AP continues transmitting the Ack or BlockACK frame with embedded beacon frame inside the same frame with the primary channel to carry beacon frame and the non-primary channel to carry Ack or BlockACK frame.

### 10.4. Beacon Embedded w/DL R-TWT TID Traffic in TDD Manner

FIG. 10 illustrates Example 10.4 of a case 510 in which the beacon is embedded with the DL R-TWT TID traffic in a Time Division Duplex (TDD) manner. The example depicts communications between an EHT AP 514 and a non-AP EHT STA1 515. The TBTT timeline 512 is shown indicating the scheduled timing for beacon 526.

As shown in this example, EHT AP 514 and non-AP EHT STA1 515 are single link STAs. At the start 516 of R-TWT SP 518, the EHT AP performs a backoff 522, obtains TXOP 518 and transmits a DL PPDU 524 frame after the start of R-TWT SP, and within the quiet interval 520. While the EHT AP is transmitting the DL PPDU, the EHT AP generates a beacon frame 528 at TBTT. The EHT AP suspends the transmission of DL PPDU 524 and embeds a beacon frame 528 inside the same frame and resumes 530 the transmission of the DL PPDU after the beacon frame. Then, the non-AP EHT STA1 sends Ack or BlockACK 532 frame as the response of receiving the DL PPDU.

Thus, the AP in this example can obtain the TXOP at TBTT, and it transmits a DL PPDU instead of a beacon frame, since in this example, it is assumed the priority of the beacon transmission is lower than R-TWT schedule priority, thereby the beacon TXOP shall not surpass the start point of the R-TWT SP. The AP knows that if it was to transmit the beacon frame, the beacon frame transmission would not be completed before the starting point of the R-TWT. So, the AP can start the TXOP for DL PPDU until the start of the R-TWT SP, and then transmit its beacon inside the R-TWT SP.

### 10.5. AP TXOP Shrinkage Before Beacon Transmission

FIG. 11 illustrates an example 610 in which AP TXOP shrinkage takes place before beacon transmission. The example depicts communications between an EHT AP 614 and a non-AP EHT STA1 615. The TBTT timeline 612 is shown indicating scheduled timing for beacon 630.

As shown in this example, EHT AP and non-AP EHT STA1 are single link STAs. In this example at the start 616 of R-TWT 618, the EHT AP contends 622 and obtains the TXOP after commencement of the R-TWT SP. The EHT AP is aware of the next TBTT (as seen in the top line with beacon 630) and the duration from the current time to this next TBTT is insufficient for the EHT AP to finish transmitting all buffered DL R-TWT TID traffic. The EHT AP in this example transmits a partial DL 624 of the buffered DL R-TWT TID traffic, making sure that the frame exchange sequence finishes before or at the next TBTT. After receiving the Ack/BA 626 in response to partial DL 624 from the non-AP EHT STA1, the EHT AP is seen sending a beacon frame 628 without contending for channel access. After the beacon transmission, the EHT AP resumes the transmission of DL PPDU 632 while considering the TXOP limitations. Then, the non-AP EHT STA1 sends an Ack or BlockACK frame 634 in response to receiving the DL PPDUs.

### 11. Brief Summary of Disclosed Protocol Elements

(1) The EHT AP with dot11 RestrictedTWTOptionImplemented set to true as a TXOP holder has the next beacon frame generation at TBTT, or other Management frame, to overlap the starting point of the R-TWT SP and should have a different procedure of processing the next beacon frame or other Management frame depending on the priority of the beacon frame, or other Management frame, transmission in relation to the priority of the R-TWT schedule.

(2) If the beacon frame or other Management frame transmission has higher priority than the R-TWT schedule, following channel access rules as defined in IEEE 802.11be Draft P802.11be_D4.0 should be updated with the highlighted parts: (a) an EHT AP with dot11 RestrictedTWTOptionImplemented set to true and thus the EHT AP is the TXOP holder, then the EHT AP shall ensure that the TXOP ends before the starting time of any active R-TWT SP advertised by itself unless the TXOP is for transmitting a beacon frame or other Management frame or the remaining portion of TXOP falling within the R-TWT SP is used for the delivery of DL frames of R-TWT DL TID(s), or to solicit the UL frames of R-TWT UL TID(s).

(b) A non-AP EHT STA with dot11 RestrictedTWTOptionImplemented set to true as a TXOP holder shall ensure the TXOP ends before the start time of any active R-TWT SPs that are advertised by its associated AP that does not correspond to a non-transmitted BSSID, unless the non-AP EHT STA is transmitting a Management frame.”

(c) When a non-AP STA that is affiliated with a non-AP MLD, and the non-AP STA operates on one link of an NSTR link pair, or one of the EMLSR or EMLMR links and is a member of a R-TWT SP on the first link; if the second non-AP STA affiliated with the same MLD is not a member of any other R-TWT SPs on the second link that overlap with the first SP, then the second non-AP STA and its associated AP (referred as the second AP), if their respective dot11 RestrictedTWTOptionImplemented equal to true, should abide by the following rules. (i) The second AP as a TXOP holder on the second link should ensure its frame exchanges end no later than T amount of time before the start time of the R-TWT SP on the first link if the second non-AP STA is the corresponding TXOP responder or one of the responders, unless the second AP is transmitting a beacon frame. (ii) The second non-AP STA as a TXOP holder on the second link should ensure its TXOP ends no later than T amount of time before the start time of the R-TWT SP on the first link, unless the second non-AP STA is transmitting a Management frame, where T equals to one of the following values: 0 if the two non-AP STAs operate on an NSTR link pair. It should be noted that the specification of IEEE 802.11be Draft P802.11be_D4.0 describes that T=0 indicates the MLD is operating on NSTR link; while T!=0 indicates the MLD is operating on EMLSR/EMLMR link. However, in the above case, only the NSTR link is being described so only one value can be assumed.

(3) If the beacon frame or other Management frame transmission has a lower priority than the R-TWT schedule, then the current channel access rule for R-TWT SP as defined in IEEE 802.11be Draft P802.11be_D4.0 can be adhered to, and the following channel access rules applied. (a) The EHT AP as the TXOP holder should not transmit a beacon frame, or other Management frame, if the beacon frame or other Management frame will overlap the starting point of R-TWT SP, which is either on the operating link of the AP, or on another link of the NSTR link pair of a non-AP MLD, that is associated with the AP MLD and to which the AP is affiliated with. (b) The EHT AP suspends any pending transmissions until the beacon has been transmitted unless the beacon frame has been deferred due to the channel access rules for R-TWT SPs as defined in IEEE 802.11be Draft P802.11be_D4.0. (c) After the R-TWT SP starting point, the EHT AP can start contending for channel access in transmitting the deferred beacon frame, or other Management frame, in support of terminating the TXOP at the start point of any R-TWT SP. (d) Rather than allowing the beacon or other management frame transmission to be deferred indefinitely the EHT AP may follow one or more of the following criteria: (i) attempt a limited number of times to transmit the beacon or other management frame, and in case it won't succeed, the EHT AP waits until the start of the next beacon frame interval or next time of transmitting Management frame; (ii) a timer is defined which starts from the start of the R-TWT, and upon expiration of the timer, the EHT AP may no longer be allowed to transmit a beacon frame or other Management frame.

(4) During the R-TWT SP, the EHT AP with dot11 RestrictedTWTOptionImplemented set to true as a TXOP holder can process the following options instead of suspending any pending transmissions until beacon or other management frame has been transmitted: (a) The EHT AP can either embed the beacon frame or other Management frame in a frequency domain division (FDD) manner, or in a time domain division (TDD) manner with the pending DL transmission. (b) When transmitting in an FDD manner, the beacon frame or other Management frame shall be embedded to occupy at least the primary 20 MHz channel to make certain that every non-AP STAs associated with this EHT AP can hear the beacon or other management frame. (c) The EHT AP can limit the TXOP of the DL pending transmissions and the corresponding frame exchange sequencies to give in the TXOP for transmitting beacon frame at the TBTT or next Management frame. (d) The EHT AP can continue the TXOP to transmit the beacon frame or other Management frame without channel contention if the EHT AP just finished the DL transmission just prior to sending the beacon frame or other Management frame. (e) The EHT AP can continue the TXOP for transmitting the remaining DL pending transmissions without channel contention if the EHT AP just finished the (embedded) beacon or other management frame transmission and is not violating the TXOP limitation.

### 12. General Scope of Embodiments

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

An apparatus for communication in a wireless network, the apparatus comprising: (a) a wireless station operating as a single station, or part of a multiple link device (MLD) having at least two stations, in which each station has at least one modem coupled to at least one radio-frequency (RF) circuit, with each RF circuit connected to one or multiple antennas; (b) a processor of said wireless station; (c) a non-transitory memory storing instructions executable by the processor for wirelessly communicating with other wireless stations on a IEEE 802.11 wireless local area network (WLAN); and (d) wherein said instructions, when executed by the processor, perform steps of a wireless communications protocol which addresses priority issues between beacon frames, and restricted target wake time (R-TWT) service period (SP) scheduling, comprising: (d) (i) wherein said wireless station can operate as either an access point (AP) station or a non-AP station; (d) (ii) determining that the wireless station, operating as an AP which is a transmit opportunity (TXOP) holder, has a scheduled beacon frame, to be transmitted which is expected to overlap with the starting point of any R-TWT SP; (d) (iii) determining that transmission of an upcoming beacon frame, would overlap on current link or on another link of the same non-simultaneous transmit-receive (NSTR) link pair of the current link with the starting point of an upcoming R-TWT SP, then said AP resolves the conflict comprising: (A) determining that the beacon frame, has a higher priority than the channel access rules for the R-TWT SP, and ignoring TXOP termination rules at the starting point of the R-TWT SP and continuing transmitting of the beacon frame; or (B) determining that the beacon frame, has a lower priority than the channel access rules for the R-TWT SP, and terminating the TXOP of the beacon frame, at the start of the R-TWT SP, whereby the AP can recontend for channel access to retransmit a beacon frame, immediately after the starting point of the R-TWT SP; and (d) (iv) determining that transmission of an upcoming beacon frame would overlap a UL or DL R-TWT TID traffic transmission sequence during an upcoming R-TWT SP, then said AP resolves the conflict comprising: (A) starting or continuing pending DL transmissions by embedding a beacon frame, within the DL transmission; or (B) limiting the length of the TXOP for the pending DL transmission and corresponding exchange sequences to give in the TXOP for transmitting the beacon frame, in a next target beacon transmission time (TBTT).

An apparatus for communication in a wireless network, the apparatus comprising: (a) a wireless station operating as a single station, or part of a multiple link device (MLD) having at least two stations, in which each station has at least one modem coupled to at least one radio-frequency (RF) circuit, with each RF circuit connected to one or multiple antennas; (b) a processor of said wireless station; (c) a non-transitory memory storing instructions executable by the processor for wirelessly communicating with other wireless stations on a IEEE 802.11 wireless local area network (WLAN); and (d) wherein said instructions, when executed by the processor, perform steps of a wireless communications protocol which addresses priority issues between beacon frames, and restricted target wake time (R-TWT) service period (SP) scheduling, comprising: (d) (i) wherein said wireless station can operate as either an access point (AP) station or a non-AP station; (d) (ii) determining that the wireless station, operating as an AP which is a transmit opportunity (TXOP) holder, has a scheduled beacon frame, to be transmitted which is expected to overlap with the starting point of any R-TWT SP; (d) (iii) determining that transmission of an upcoming beacon frame, would overlap on a current link or on another link of the same non-simultaneous transmit-receive (NSTR) link pair of the current link with the starting point of an upcoming R-TWT SP, then said AP resolves the conflict comprising: (A) determining that the beacon frame, has a higher priority than the channel access rules for the R-TWT SP, and ignoring TXOP termination rules at the starting point of the R-TWT SP and continuing transmitting of the beacon frame; or (B) determining that the beacon frame, has a lower priority than the channel access rules for the R-TWT SP, and terminating the TXOP of the beacon frame, at the start of the R-TWT SP, whereby the AP can recontend for channel access to retransmit a beacon frame, immediately after the starting point of the R-TWT SP; (d) (iv) determining that transmission of an upcoming beacon frame would overlap a UL or DL R-TWT TID traffic transmission sequence during an upcoming R-TWT SP, then said AP resolves the conflict comprising: (A) starting or continuing pending DL transmissions by embedding a beacon frame, in a frequency domain division (FDD) manner or in a time domain division (TDD) manner, within the DL transmission; or (B) limiting the length of the TXOP for the pending DL transmission and corresponding exchange sequences to give in the TXOP for transmitting the beacon frame, in a next target beacon transmission time (TBTT); and (d) (v) wherein embedding of the beacon frame is controlled by bits within a R-TWT traffic control field which indicates if embedding is allowed, and whether this applies to embedding in an FDD manner or a TDD manner.

A method of communicating in a wireless network, the apparatus comprising: (a) communicating between wireless stations on a IEEE 802.11 wireless local area network (WLAN), in which each wireless station operates as a single station, or is part of a multiple link device (MLD) having at least two stations; (b) performing steps of a wireless communications protocol which addresses priority issues between beacon frames, and restricted target wake time (R-TWT) service period (SP) scheduling; (c) wherein each said wireless stations can operate as either an access point (AP) station or a non-AP station; (d) determining that the wireless station, operating as an AP which is a transmit opportunity (TXOP) holder, has a scheduled beacon frame, to be transmitted which is expected to overlap with the start point of any R-TWT SP; (e) determining that transmission of an upcoming beacon frame, would overlap on a current link or on another link of the same non-simultaneous transmit-receive (NSTR) link pair of the current link with the starting point of an upcoming R-TWT SP, then said AP resolves the conflict comprising: (A) determining that the beacon frame, has a higher priority than the channel access rules for the R-TWT SP, and ignoring TXOP termination rules at the starting point of the R-TWT SP and continuing transmitting of the beacon frame; or (B) determining that the beacon frame, has a lower priority than the channel access rules for the R-TWT SP, and terminating the TXOP of the beacon frame, at the start of the R-TWT SP, whereby the AP can recontend for channel access to retransmit a beacon frame, immediately after the starting point of the R-TWT SP; and (f) determining that transmission of an upcoming beacon frame would overlap a UL or DL R-TWT TID traffic transmission sequence during an upcoming R-TWT SP, then said AP resolves the conflict comprising: (A) starting or continuing pending DL transmissions by embedding a beacon frame, within the DL transmission; or (B) limiting the length of the TXOP for the pending DL transmission and corresponding exchange sequences to give in the TXOP for transmitting the beacon frame, in a next target beacon transmission time (TBTT).

The apparatus or method of any preceding implementation, wherein embedding the beacon frame, within the DL transmission comprises embedding the beacon frame, in a frequency domain division (FDD) manner, or in a time domain division (TDD) manner.

The apparatus or method of any preceding implementation, wherein when embedding the beacon frame, within the DL transmission in an FDD manner, the beacon frame is embedded to occupy at least the primary 20 MHz channel to allow non-AP stations associated with the AP to hear the beacon frame.

The apparatus or method of any preceding implementation, wherein embedding of the beacon frame is controlled by bits within a R-TWT traffic control field which indicates if embedding is allowed, and whether this applies to embedding in an FDD manner or a TDD manner.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has. a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for communication in a wireless network, the apparatus comprising:
(a) a wireless station operating as a single station, or part of a multiple link device (MLD) having at least two stations, in which each station has at least one modem coupled to at least one radio-frequency (RF) circuit, with each RF circuit connected to one or multiple antennas;
(b) a processor of said wireless station;
(c) a non-transitory memory storing instructions executable by the processor for wirelessly communicating with other wireless stations on a IEEE 802.11 wireless local area network (WLAN); and
(d) wherein said instructions, when executed by the processor, perform steps of a wireless communications protocol which addresses priority issues between beacon frames, and restricted target wake time (R-TWT) service period (SP) scheduling, comprising:
(i) wherein said wireless station can operate as either an access point (AP) station or a non-AP station;
(ii) determining that the wireless station, operating as an AP which is a transmit opportunity (TXOP) holder, has a scheduled beacon frame, to be transmitted which is expected to overlap with the starting point of any R-TWT SP;
(iii) determining that transmission of an upcoming beacon frame, would overlap on current link or on another link of the same non-simultaneous transmit-receive (NSTR) link pair of the current link with the starting point of an upcoming R-TWT SP, then said AP resolves the conflict comprising: (A) determining that the beacon frame, has a higher priority than the channel access rules for the R-TWT SP, and ignoring TXOP termination rules at the starting point of the R-TWT SP and continuing transmitting of the beacon frame; or (B) determining that the beacon frame, has a lower priority than the channel access rules for the R-TWT SP, and terminating the TXOP of the beacon frame, at the start of the R-TWT SP, whereby the AP can recontend for channel access to retransmit a beacon frame, immediately after the starting point of the R-TWT SP; and
(iv) determining that transmission of an upcoming beacon frame would overlap a UL or DL R-TWT TID traffic transmission sequence during an upcoming R-TWT SP, then said AP resolves the conflict comprising: (A) starting or continuing pending DL transmissions by embedding a beacon frame, within the DL transmission; or (B) limiting the length of the TXOP for the pending DL transmission and corresponding exchange sequences to give in the TXOP for transmitting the beacon frame, in a next target beacon transmission time (TBTT).

2. The apparatus of claim 1, wherein embedding the beacon frame, within the DL transmission comprises embedding the beacon frame, in a frequency domain division (FDD) manner, or in a time domain division (TDD) manner.

3. The apparatus of claim 2, wherein when embedding the beacon frame, within the DL transmission in an FDD manner, the beacon frame is embedded to occupy at least the primary 20 MHz channel to allow non-AP stations associated with the AP to hear the beacon frame.

4. The apparatus of claim 2, wherein embedding of the beacon frame is controlled by bits within a R-TWT traffic control field which indicates if embedding is allowed, and whether this applies to embedding in an FDD manner or a TDD manner.

5. An apparatus for communication in a wireless network, the apparatus comprising:
(a) a wireless station operating as a single station, or part of a multiple link device (MLD) having at least two stations, in which each station has at least one modem coupled to at least one radio-frequency (RF) circuit, with each RF circuit connected to one or multiple antennas;
(b) a processor of said wireless station;
(c) a non-transitory memory storing instructions executable by the processor for wirelessly communicating with other wireless stations on a IEEE 802.11 wireless local area network (WLAN); and
(d) wherein said instructions, when executed by the processor, perform steps of a wireless communications protocol which addresses priority issues between beacon frames, and restricted target wake time (R-TWT) service period (SP) scheduling, comprising:
(i) wherein said wireless station can operate as either an access point (AP) station or a non-AP station;
(ii) determining that the wireless station, operating as an AP which is a transmit opportunity (TXOP) holder, has a scheduled beacon frame, to be transmitted which is expected to overlap with the starting point of any R-TWT SP;
(iii) determining that transmission of an upcoming beacon frame, would overlap on a current link or on another link of the same non-simultaneous transmit-receive (NSTR) link pair of the current link with the starting point of an upcoming R-TWT SP, then said AP resolves the conflict comprising: (A) determining that the beacon frame, has a higher priority than the channel access rules for the R-TWT SP, and ignoring TXOP termination rules at the starting point of the R-TWT SP and continuing transmitting of the beacon frame; or (B) determining that the beacon frame, has a lower priority than the channel access rules for the R-TWT SP, and terminating the TXOP of the beacon frame, at the start of the R-TWT SP, whereby the AP can recontend for channel access to retransmit a beacon frame, immediately after the starting point of the R-TWT SP;
(iv) determining that transmission of an upcoming beacon frame would overlap a UL or DL R-TWT TID traffic transmission sequence during an upcoming R-TWT SP, then said AP resolves the conflict comprising: (A) starting or continuing pending DL transmissions by embedding a beacon frame, in a frequency domain division (FDD) manner or in a time domain division (TDD) manner, within the DL transmission; or (B) limiting the length of the TXOP for the pending DL transmission and corresponding exchange sequences to give in the TXOP for transmitting the beacon frame, in a next target beacon transmission time (TBTT); and
(v) wherein embedding of the beacon frame is controlled by bits within a R-TWT traffic control field which indicates if embedding is allowed, and whether this applies to embedding in an FDD manner or a TDD manner.

6. The apparatus of claim 5, wherein when embedding the beacon frame, within the DL transmission in an FDD manner, the beacon frame is embedded to occupy at least the primary 20 MHz channel to allow non-AP stations associated with the AP to hear the beacon frame.

7. A method of communicating in a wireless network, the apparatus comprising:
(a) communicating between wireless stations on a IEEE 802.11 wireless local area network (WLAN), in which each wireless station operates as a single station, or is part of a multiple link device (MLD) having at least two stations;
(b) performing steps of a wireless communications protocol which addresses priority issues between beacon frames, and restricted target wake time (R-TWT) service period (SP) scheduling;
(c) wherein each said wireless stations can operate as either an access point (AP) station or a non-AP station;
(d) determining that the wireless station, operating as an AP which is a transmit opportunity (TXOP) holder, has a scheduled beacon frame, to be transmitted which is expected to overlap with the start point of any R-TWT SP;
(e) determining that transmission of an upcoming beacon frame, would overlap on a current link or on another link of the same non-simultaneous transmit-receive (NSTR) link pair of the current link with the starting point of an upcoming R-TWT SP, then said AP resolves the conflict comprising: (A) determining that the beacon frame, has a higher priority than the channel access rules for the R-TWT SP, and ignoring TXOP termination rules at the starting point of the R-TWT SP and continuing transmitting of the beacon frame; or (B) determining that the beacon frame, has a lower priority than the channel access rules for the R-TWT SP, and terminating the TXOP of the beacon frame, at the start of the R-TWT SP, whereby the AP can recontend for channel access to retransmit a beacon frame, immediately after the starting point of the R-TWT SP; and
(f) determining that transmission of an upcoming beacon frame would overlap a UL or DL R-TWT TID traffic transmission sequence during an upcoming R-TWT SP, then said AP resolves the conflict comprising: (A) starting or continuing pending DL transmissions by embedding a beacon frame, within the DL transmission; or (B) limiting the length of the TXOP for the pending DL transmission and corresponding exchange sequences to give in the TXOP for transmitting the beacon frame, in a next target beacon transmission time (TBTT).

8. The method of claim 7, wherein embedding the beacon frame within the DL transmission comprises embedding the beacon frame, in a frequency domain division (FDD) manner, or in a time domain division (TDD) manner.

9. The method of claim 8, wherein when embedding the beacon frame, within the DL transmission in an FDD manner, the beacon frame is embedded to occupy at least the primary 20 MHz channel to allow non-AP stations associated with the AP to hear the beacon frame.

10. The method of claim 8, wherein embedding of the beacon frame is controlled by bits within a R-TWT traffic control field which indicates if embedding is allowed, and whether this applies to embedding in an FDD manner or a TDD manner.
